(19) United States
(12) Patent Application Publication
(10) Pub. No.: US 2004/0010548 A1
(43) Pub. Date: Jan. 15, 2004

(54) Apparatus and method for enhancing voicemail functionality with conferencing capabilities

(75) Inventors: Rick Allen Hamilton II, Charlottesville, VA (US); James Wesley Seaman, Falls Church, VA (US)

Correspondence Address: Rudolf. O Siegesmund, Suite 2000, 4627 N. Central Expressway, Dallas, TX, 75205-4017, US

(73) Assignee: International Business machines Croporation, Armonk, NY

(21) Appl. No.: 10/195,164

(22) Filed: Jul. 11, 2002

(51) Int. Cl. G06F 15/16

(52) U.S. Cl. 709/204; 709/245

(57) ABSTRACT

The present invention comprises a conference call program having a host program, an invitee program, and a monitor program which cooperate with each other and interact with the conference call participants' voicemail system. The host is responsible for arranging the particulars of the conference call and the invitees are the people the host will invite to attend the conference call. The host program then sends the invitation out to the invitees over the telephone and obtains the conference call telephone number and passcode. The invitees can RSVP to the invitation and the invitee program forwards the invitees' RSVPs back to the host in the form of a telephone message. The monitor program tracks the flow of invitations, invitees, and RSVPs. The monitor program then notifies the host prior to the conference call who will and will not be attending.

### FIELD OF THE INVENTION

The present invention is an apparatus and method for enhancing voice mail programs by providing the ability to coordinate conference calls.

### BACKGROUND OF THE INVENTION

Today's businesspeople travel much more frequently than ever before and have almost continuous access to a either a cellular or a conventional telephone in any given stage of travel. The telephone is often the most convenient and efficient method of communication between businesspeople and their clients. Frequently, businesspeople also need to collaborate with the home organization and with clients, vendors, and business partners.

The conference call has become an increasingly popular tool among businesspeople. The traveling businessperson needs a quick and easy way to set up conference calls. Often, the need for a conference call arises at the last minute based on a client call or due to some other intervening factor that must be acted upon quickly. Since corporate telephone mail systems are already in widespread use, integration of conference call capability is a natural addition to the other conveniences embedded in these systems.

Similar tools are available via various computer applications, such as Lotus Notes. However, the telephone mail system has distinct advantages in that the only equipment that a conference call participant needs to complete the conference call process is a telephone. If a client call comes in to a traveling businessman and a collaborative session is necessary, a computer based solution will require the host to wait until he reaches the destination (perhaps hours later), so that he can configure the computer equipment and proceed to set up the conference call. With the telephone mail option, all of these steps can be eliminated and the conference call can be arranged immediately when required. Therefore, a need exist for a method and apparatus to set up a conference call through a voicemail system that can be utilized by the conference call participants completely by telephone.

### SUMMARY OF THE INVENTION

The present invention is an apparatus and method for scheduling a conference call based on existing voicemail systems. The present invention comprises a conference call program having a host program, an invitee program, and a monitor program that cooperate with each other and interact with the conference call participants' voicemail system. Conference call participants are broken into two groups: the host and the invitee. The host is responsible for arranging the particulars of the conference call and the invitees are the people the host will invite to attend the conference call. The host sets up the date, time, location, RSVP deadline, and possible comments to the conference call in a recorded telephone message for the invitees. The host program then sends the invitation out to the invitees over the telephone and obtains the conference call telephone number and passcode. The invitees can RSVP to the invitation as either accepting or declining and can optionally add comments to their RSVP. The invitee program then forwards the invitees' RSVPs back to the host in the form of a telephone message. The monitor program tracks the flow of invitations, invitees, and RSVPs. When a deadline for RSVPs set by the host passes, the monitor program lists the non-responsive parties as declining due to a lack of response. The monitor program then notifies the host prior to the conference call who will and will not be attending. The host program also provides the host with various options to review RSVPs and edit the conference call particulars. The invitee program also provides the invitee with various options to review their RSVPs and edit RSVPs they have already sent back to the host.

### BRIEF DESCRIPTION OF THE DRAWINGS

FIG. 1 is an illustration of a distributed data network.

FIG. 2 is an illustration of a data processing system.

FIG. 3 is an illustration of a data processing system.

FIG. 4 is an illustration of the logic behind the host program.

FIG. 5 is an illustration of the logic behind the invitee program.

FIG. 6 is an illustration of the logic behind the monitor program.

FIG. 7A is a block diagram of the conference call program located in the memory of a telecommunications system.

FIG. 7B is a block diagram of the conference call program.

### DETAILED DESCRIPTION OF THE PREFERRED EMBODIMENT

As used herein, the term conference call means a gathering of people for communicative purposes. Most conference calls involve a third party conference calling center which issues a telephone number and passcode to all the conference call participants (the host and invitees). The participants call the telephone number at the appropriate time, enter the passcode, and the conference calling center connects the participants. In another type of conference call, which is particularly useful when many of the participants are in the same company, a conference room may be designated for many of the invitees to go to for the conference call. Telephones set up in the conference room are then used to either call the remaining participants or the conference calling center. As used herein, the term host means the initiator of a conference call or other gathering. The host is the person who decides the date, time, and other details of the conference call or gathering and invites the invitees. As used herein, the term invitee means a person who has been invited to attend a conference call or gathering. The invitees can be either internal or external. Internal invitees or peers are people within the same telephone network as the host. Internal invitees are typically people in the same company as the host, but are not limited as such. External invitees or externals are people who are not on the same telephone network as the host. These people can be in the same company as the host, but are typically clients, vendors, business partners and the like; however they are not limited as such. As used herein, the term voice mail system means a system on a telephone, either conventional or cellular, which organizes and/or stores a person's telephone messages. As used herein, the term telephone mail system shall have the same meaning as the term voice mail system. Voice mail systems and telephone mail systems are usually automated, but are not limited as such. As used herein, the term system means the implementation hardware, software, or combination used to store and operate the present invention. The system may be the host's voicemail system, the telephone system of the host's company, the internet, an independent third party system, or any other communications system capable of implementing the present invention.

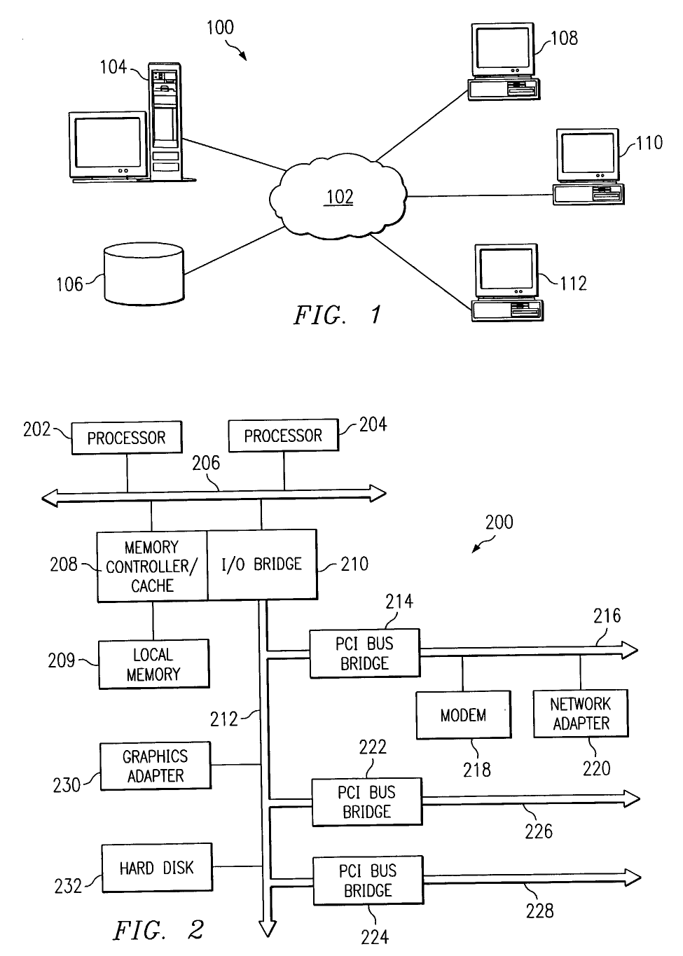

FIG. 1 depicts a pictorial representation of a distributed data processing system in which the present invention may be implemented and is intended as an example, and not as an architectural limitation for the processes of the present invention. Distributed data processing system 100 is a network of computers which contains a network 102, which is the medium used to provide communication links between the various devices and computers connected together within distributed data processing system 100. Network 102 may include permanent connections, such as wire or fiber optic cables, or temporary connections made through telephone connections. In the depicted example, a server 104 is connected to network 102 along with storage unit 106. In addition, clients 108, 110, and 112 also are connected to a network 102. Clients 108, 110, and 112 may be, for example, personal computers or network computers.

For purposes of this application, a network computer is any computer, coupled to a network, which receives a program or other application from another computer coupled to the network. In the depicted example, server 104 provides Web based applications to clients 108, 110, and 112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as, an intranet, a local area network (LAN), or a wide area network (WAN).

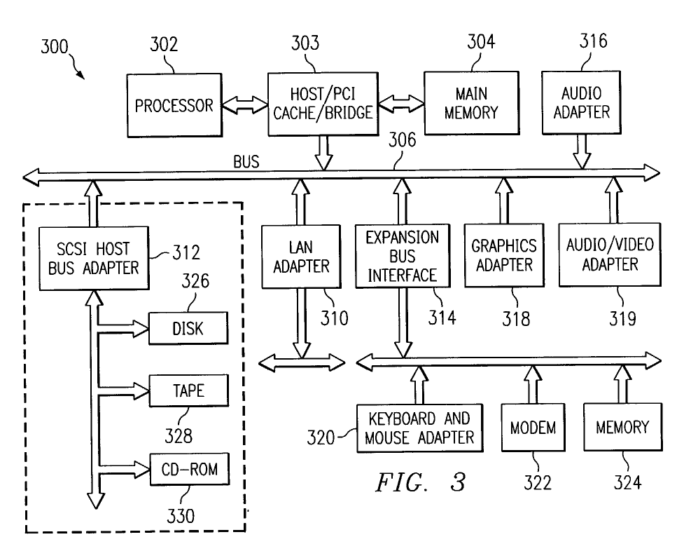

Referring to FIG. 2, a block diagram depicts a data processing system, which may be implemented as a server, such as server 104 in FIG. 1 in accordance with the present invention. Data processing system 200 may be a symmetric multiprocessor (SMP) system including a plurality of processors such as first processor 202 and second processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to first PCI local bus 216. Modem 218 may be connected to first PCI local bus 216. Typical PCI bus implementations will support four PCI expansion slots or add-in connectors. Communications links to clients 108, 110 and 112 in FIG. 1 may be provided through modem 218 and network adapter 220 connected to first PCI local bus 216 through add-in boards. Additional PCI bus bridges such as second PCI bus bridge 222 and third PCI bus bridge 224 provide interfaces for additional PCI local buses such as second PCI local bus 226 and third PCI local bus 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as an optical disk drive and the like also may be used in addition or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

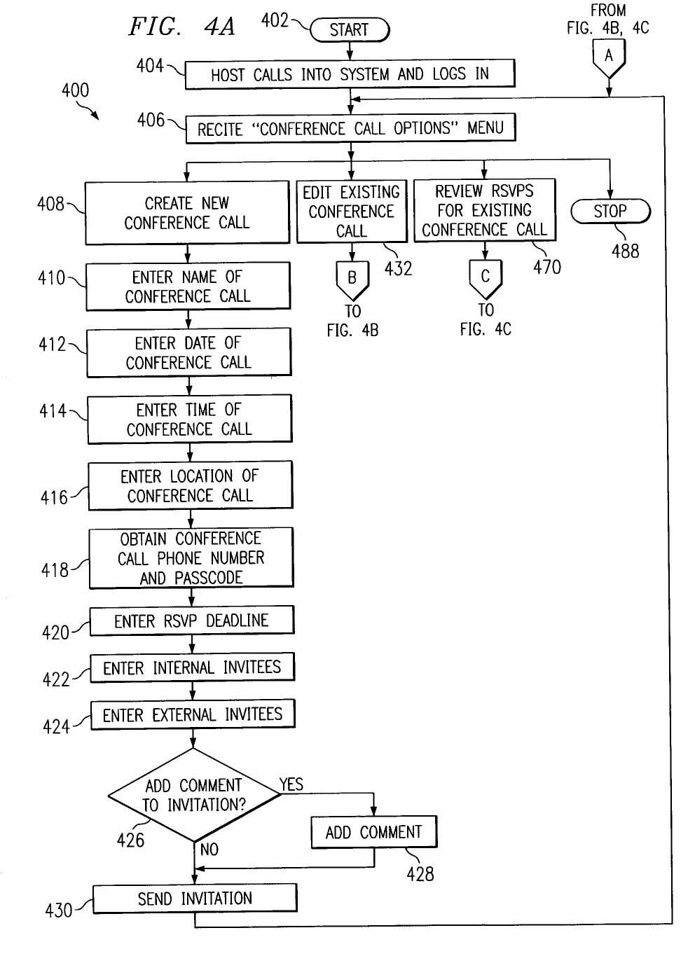

With reference now to FIG. 3, a block diagram illustrates a data processing system in which the invention may be implemented. Data processing system 300 is an example of either a stand-alone computer, if not connected to distributed data processing system 100, or a client computer, if connected to distributed data processing system 100. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 303. PCI bridge 303 also may include an integrated memory controller and cache memory for Processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (ANV) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system, such as Java, may run in conjunction with the operating system and provides calls to the operating system from Java programs or applications executing on data processing system 300. “Java” is a trademark of Sun Microsystems, Incorporated. Instructions for the operating system, the object-oriented operating system, and applications or programs may be located on storage devices, such as hard disk drive 326, and they may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. For example, data processing system 300, if configured as a network computer, may not include SCSI host bus adapter 312, hard disk drive 326, tape drive 328, and CD-ROM 330, as noted by the box with the dotted line in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or user-generated data. The depicted example in FIG. 3 and above-described examples are not meant to imply architectural limitations with respect to the present invention. It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media, such a floppy disc, a hard disk drive, a RAM, and CD-ROMs, and transmission-type media, such as digital and analog communications links.

Modern telecommunications systems are almost inseparable from their computer components and the internet. Accordingly, those skilled in the art are aware of ways and means to configure a voicemail system with additional options such as the programs contained within the present invention. Those skilled in the art are also aware of how to configure computer systems with voicemail functionality such that a user can send, receive, edit and delete telephone messages. Furthermore, those skilled in the art are aware of how to configure a telecommunications system and/or a computer to make automated outgoing telephone calls. The present invention can be implemented on a variety of different telecommunications systems including, but not limited to: the host's telecommunications system, the invitee's telecommunications system, a third party telecommunications system, or as an extension of a person's cellular telecommunications network.

In entering information into host program 400, invitee program 500, or monitor program 600, the information may be entered by speaking into the handset of a telephone, entered via the touchpad of a telephone, entered over the internet, or by any other data entry method. Those skilled in the art are aware of how to configure a computer to receive information over the internet and transmit the information via telephone calls to various parties. Those skilled in the art are also aware of how to configure a telephone system to accept user input via telephone keypads and audible voice signals. Furthermore, the steps embodied in host program 400, invitee program 500, and monitor program 600 are not necessarily limited to the order as presented herein.

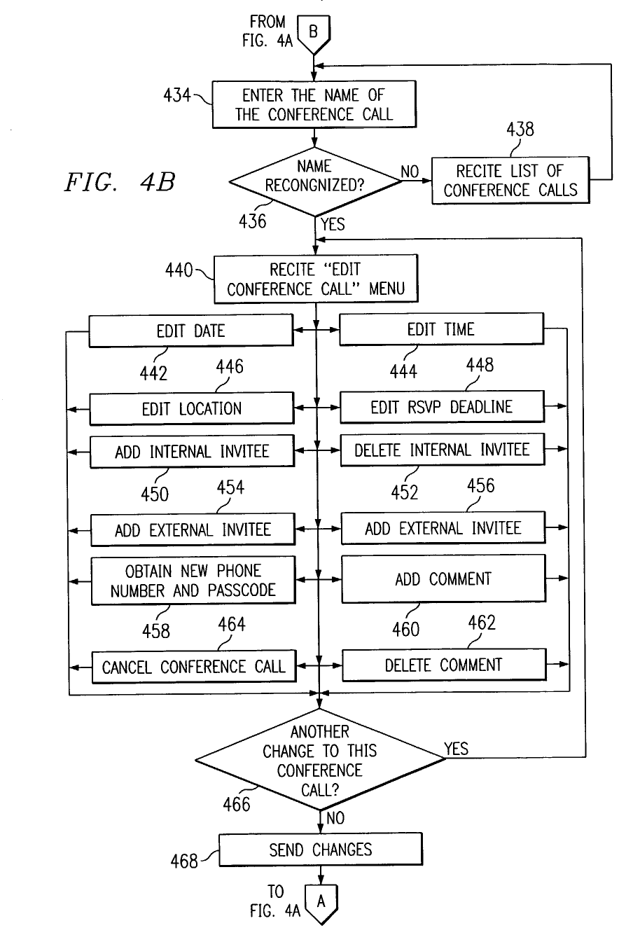

FIG. 4 is a flowsheet of the logic behind host program 400. Host program 400 is used by the host of a conference call to set up the conference call and invite the invitees. Host program 400 may also be used to invite people to a traditional conference or other type of gathering, such as a staff meeting, lunch, or party. Host program 400 starts (402) when the host calls into the system and logs in (404). If host program 400 is implemented on the same system as host's voice mail system, this may be as simple as picking up the telephone and/or dialing an extension. If host program 400 is implemented on an external system, then the host will have to call a telephone number and give a password to identify himself as the host. Host program 400 then recites the host's “conference call options” menu (406). At this level, the host has four options: create a new conference call, edit an existing conference call, review the RSVPs for existing conference calls, or end the call. Each option is discussed in detail below.

The first option the host has is to create a new conference call (408). If he chooses to create a new conference call, the host enters a name for this particular conference call (410). The user then enters the date of the conference call (412). The user then enters the time of the conference call (414). The user then enters the location of the conference call, if applicable (416). If all of the participants are in different locations, then the location is not necessary. However, if some of the participants will be gathering in a particular office or conference room, then the location is relevant. Host program 400 has the capacity to accept multiple locations if the host desires to do so (i.e. invitees 1-5 go to location A, invitees 6-10 go to location B).

The host then enters a command for host program 400 to obtain the telephone number and passcode for the conference call (418). Those skilled in the art are aware of existing systems for automatic request and receipt of telephone numbers and pass codes for conference calls. Those skilled in the art are further aware of various methods to configure a computer program to obtain a conference call telephone number and passcode from an outside source. If the conference call is conducted through a third party conference calling center, then both the telephone number and passcode will be necessary. If the conference call is to be conducted by another means (i.e. through the host's telephone system), then in the case of internal invitees, the extension to call for the conference call may be substituted for the telephone number and passcode. In the case of external invitees, a company telephone number and extension or a direct telephone number can be substituted for the telephone number and passcode. Alternatively, the host could enter a pre-existing telephone number and passcode or equivalent information if he prefers to do so. The host then enters a deadline for the invitees to respond to the invitation, referred to as the RSVP deadline (420). An infinite amount of deadlines are available to the host, but typical deadlines include the actual time of the conference call, an hour before the conference call, or a day before the conference call.

The host then enters the internal invitees for the conference call (422). If the system is on the host's voicemail system, the host can enter merely the name of the internal invitee or the name and extension of the internal invitee as is required by the host's telephone system. If the system is an independent third party system, the host will have to enter the names and telephone numbers (possibly with extensions) of the internal invitees. The host then enters the external invitees (424). Unless the system is implemented on the invitee's voicemail system, the host will generally have to enter the names and telephone numbers (possibly with extensions) of the external invitees. The host is then given the option to add a comment to the invitation (426). If the host decides to add a comment, then he adds the comment (428) and host program proceeds to step 430. If the host decides not to add a comment, then host program 400 proceeds directly to step 430. Host program 400 will accept multiple comments if the host so desires.

Host program 400 then obtains the conference call telephone number and password, sends the invitation to the invitees, notifies monitor program 600 of the list of invitees and the RSVP deadline, if any (430) and returns to step 406. In sending the invitation to the invitees, host program 400 calls each of the invitees and informs them that they have been invited to attend a conference call. If the invitee does not answer the call, host program 400 can leave a message on the invitee's voicemail. If the invitee does answer, host program 400 can either give the invitee a telephone number to call to RSVP to the conference call or accept an RSVP to the conference call at that time. Host program 400 can also send the invitation by other means such as email, fax, or regular mail. During the process of creating a conference call (Steps 408 through 430) the host may lack some of the information sought by host program 400. In that event, the host may simply choose to omit that information from the conference call invitation and proceed with the conference call creation process. The host then has the option to go back and add the omitted information to the invitation as discussed in steps 432 through 468.

The second option the host has under the “conference call options” menu at step 406 is to edit an existing conference call (432). Upon selecting this option, the host enters the name of the conference call desires to edit (434). Host program 400 then makes a determination of whether the name entered by the host is recognized as a conference call stored in the system memory (436). If the name is not recognized, host program 400 notifies the host that the entered name is not a valid name and recites a list of conference calls stored in memory (438) and returns to step 434. Steps 432-436 can be omitted if the host only has set up one conference call. If host program 400 recognizes the entered name, then host program 400 recites the “edit conference call” menu (440). In the “edit conference call” menu, the host can select one of twelve options to modify the invitation to the conference call. The twelve options are as follows:

1. Edit date (442)—This option allows the host to enter a new date for the conference call. The old date is then deleted.

2. Edit time (444)—This option allows the host to enter a new time for the conference call. The old time is then deleted.

3. Edit location (446)—This option allows the host to create a new location if none previously existed or change or delete the location if one exists. If the location is changed, the old location is deleted.

4. Edit RSVP deadline (448)—This option allows the host to enter a new RSVP deadline for the conference call. The old RSVP deadline is then deleted.

5. Add internal invitee (450)—This option allows the host to invite a new internal invitee.

6. Delete internal invitee (452)—This option allows the host to un-invite an existing internal invitee.

7. Add external invitee (454)—This option allows the host to invite a new external invitee.

8. Delete external invitee (456)—This option allows the host to un-invite an existing external invitee.

9. Edit telephone number and passcode (458)—This option allows the host to command host program 400 to obtain a new telephone number and passcode or similar information as discussed in reference to step 418. The old telephone number and passcode are deleted.

10. Add comment (460)—This option allows the host to add a new comment to the invitation.

11. Delete comment (462)—This option allows the host to delete a comment from the invitation. If multiple comments are contained in the invitation, then the host is given a list of comments to choose from.

12. Cancel conference call (464)—This option allows the host to cancel the conference call.

Regardless of which of the above twelve options is selected by the host, host program 400 proceeds to step 466. At step 466, the host is prompted as to whether there are additional changes to be made to the present conference call (466). If there are additional changes to be made, then host program 400 returns to step 440. If there are no additional changes to be made, then host program 400 send the changes to the invitees, notifies monitor program 600 of the change in the RSVP deadline and/or invitees, if any (468) and returns to step 406. In sending the changes to the invitees, host program 400 only sends the changes to invitees that are affected by the changes. For example, if an invitee, either internal or external, is added or deleted, then the change need only be sent to the added/deleted invitee. Similarly, changes to the RSVP deadline need not be sent to parties which have already sent their RSVP to the host. Other changes, such as changes in the telephone number and passcode, time, date, location, and any changes in the comments, are sent to all of the invitees. Ultimately, who host program 400 should send the edited invitation to is the host's decision, and host program 400 can be configured such that the host can choose who receives the edited invitations.

Moreover, prior to sending the changes to the invitees, the host is allowed to determine if the invitees' RSVP status needs to be reset. A minor change, such as adding or deleting an invitee, does not affect the RSVP status. More significant changes, like changes in the time, date, location, and any changes in the comments, will reset the invitees' RSVP status. Ultimately, whether host program 400 resets anybody's RSVP status is the host's decision, and host program 400 can be configured such that the host can choose whose RSVP status gets reset.

The third option the host has under the “conference call options” menu at step 406 is to review the RSVPs for an existing conference call (470). Upon selecting this option, the host enters the name of the conference call he desires to edit (472). Host program 400 then makes a determination of whether the name entered by the host is recognized as a conference call stored in the system memory (474). If the name is not recognized, host program 400 notifies the host that the entered name is not a valid name and recites a list of conference calls stored in memory (476) and returns to step 472. Steps 472—476 can be omitted if the host only has set up one conference call. If host program 400 recognizes the entered name, then host program 400 recites the “review RSVPs” menu (478). In the “review RSVPs” menu, the host can select one of the following three options:

1. Review internal RSVPs (480)—This option allows the host to review the RSVPs for all of the internal invitees.

2. Review external RSVPs (482)—This option allows the host to review the RSVPs for all of the external invitees.

3. Review all RSVPs (484)—This option allows the host to review the RSVPs for all of the invitees.

Regardless of which of the above three options is selected by the host, host program 400 proceeds to step 486. At step 486, the host is prompted as to whether he would like to review the RSVPs for this conference call again (486). If he desires to review the RSVPs for the selected conference call again, or perhaps review a different set of RSVPs for the same conference call, then host program 400 returns to step 478. If he does not desire to review the RSVPs again, then host program 400 returns to step 406.

The fourth option the host has under the “conference call options” menu at step 406 is to quit host program 400 (488). In that case, the host either hangs up the telephone or enters a command which host program 400 will recognize as the host's intention to terminate host program 400.

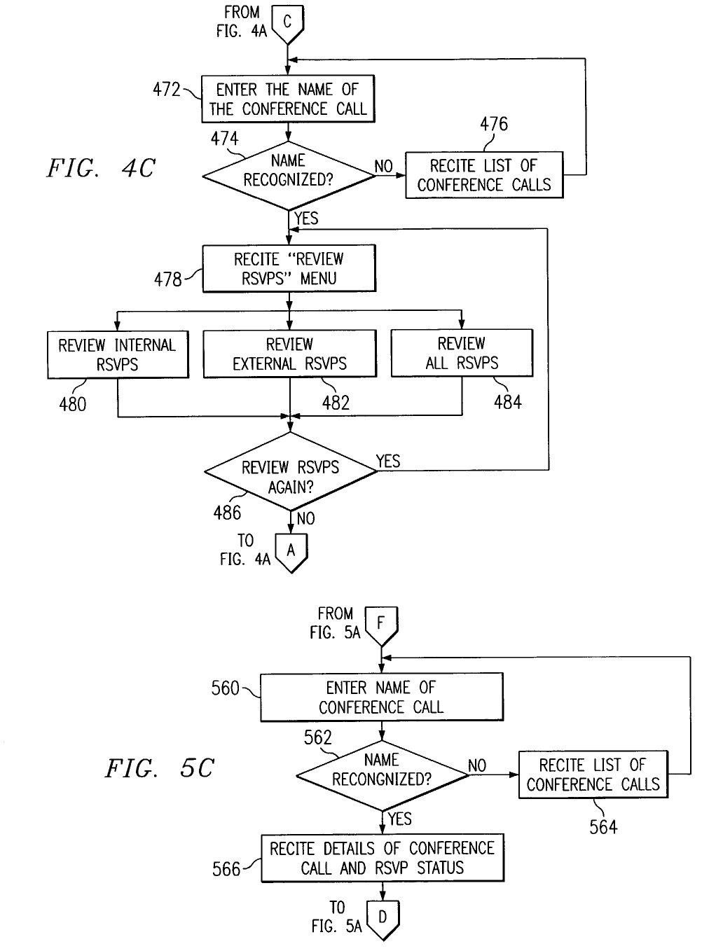

FIG. 5 is a flowsheet of the invitee program 500. Invitee program 500 is used by the invitee of a conference call to respond to the invitation sent by the host of a conference call. Invitee program 500 starts (502) either when the invitee calls into the system (and logs in) or when host program 400 calls the invitee with an invitation and the invitee answers the call (504). If the invitee calls into a voicemail system and invitee program 500 is implemented on the same system as invitee's voice mail system, the act of calling in may be as simple as picking up the telephone and/or dialing an extension. If invitee program 500 is implemented on an external system, then the invitee will have to call a telephone number and give a password to identify himself as the invitee. Regardless of whether the invitee responds or logs in, invitee program 500 recites the new invitations that the invitee has received since the last log in (506). Invitee program 500 then recites the invitee's “conference call options” menu (508). At this level, the invitee has four options: RSVP to a conference call, edit an RSVP to a conference call, review RSVPs for conference calls, or end the call. Each option is discussed in detail below.

The first option the invitee has under the “conference call options” menu at step 508 is to RSVP to the invitation to a conference call (510). Upon selecting this option, the invitee enters the name of the conference call he desires to RSVP to (512). Invitee program 500 then makes a determination of whether the name entered by the invitee is recognized as a conference call stored in the system memory (514). If the name is not recognized, invitee program 500 notifies the invitee that the entered name is not a valid name and recites a list of conference calls stored in memory (516) and returns to step 512. Steps 512-516 can be omitted if the invitee is only invited to one conference call. If invitee program 500 recognizes the entered name, then invitee program 500 recites the details regarding the specified conference call (518). The details recited in step 518 include the date, time, location, telephone number and passcode, the RSVP deadline, and any comments that the host has attached to the invitation. Invitee program 500 then recites the “accept/decline” menu where the invitee has various options on how to reply to the invitation (520). The options under the “accept/decline” menu are:

1. Accept the invitation (522)—This option allows the invitee to accept the host's invitation to the conference call without attaching any comments to the RSVP.

2. Decline the invitation (524)—This option allows the invitee to decline the host's invitation to the conference call without attaching any comments to the RSVP.

3. Accept the invitation with comments (526)—This option allows the invitee to accept the host's invitation to the conference call and attach comments to the RSVP.

4. Decline the invitation with comments (528)—This option allows the invitee to decline the host's invitation to the conference call and attach comments to the RSVP.

If the invitee decides to either accept the invitation (without comments) under step 522 or decline the invitation (without comments) under step 524, then invitee program 500 proceeds to step 532. If the user decides to accept the invitation with comments under step 526 or decline the invitation with comments under step 528, then invitee program 500 proceeds to step 530 where the invitee has the opportunity to make as many comments as he desires (530). Typical comments may include “I can attend, but I have to leave at 6 pm”, “I can't attend, but I have accepted the invitation and one of my associates will be attending in my absence”, or “I can't attend, but if the conference call were moved to 4 pm, I could attend.” Invitee program 500 then proceeds to step 532. At step 532, invitee program 500 sends the RSVP back to the host and notifies monitor program 600 of the RSVP status of the invitee for the specified conference call (532). Invitee program 500 then returns to step 508.

The second option the invitec has under the “conference call options” menu at step 508 is to edit the RSVPs the invitee has already sent for future conference calls (534). Upon selecting this option, the invitee enters the name of the conference call he desires to edit (536). Invitee program 500 then makes a determination of whether the name entered by the invitee is recognized as a conference call stored in the system memory (538). If the name is not recognized, invitee program 500 notifies the invitee that the entered name is not a valid name and recites a list of conference calls stored in memory (540) and returns to step 536. Steps 536-540 can be omitted if the invitee is only invited to one conference call. If invitee program 500 recognizes the entered name, then invitee program 500 recites the details and RSVP status regarding the specified conference call (542). The details recited in step 542 include the date, time, location, telephone number and passcode, the RSVP deadline, current RSVP status (i.e. accepted, declined, etc.) and any comments that the host has attached to the invitation. Invitee program 500 then recites the “accept/decline” menu where the invitee has various options on how to reply to the invitation (544). The options under the “accept/decline” menu are:

1. Accept the invitation (546)—This option allows the invitee to accept the host's invitation to the conference call without attaching any comments to the RSVP.

2. Decline the invitation (548)—This option allows the invitee to decline the host's invitation to the conference call without attaching any comments to the RSVP.

3. Accept the invitation with comments (550)—This option allows the invitee to accept the host's invitation to the conference call and attach comments to the RSVP.

4. Decline the invitation with comments (552)—This option allows the invitee to decline the host's invitation to the conference call and attach comments to the RSVP.

If the invitee decides to either accept the invitation (without comments) under step 546 or decline the invitation (without comments) under step 548, then invitee program 500 proceeds to step 556. If the user decides to accept the invitation with comments under step 550 or decline the invitation with comments under step 552, then invitee program 500 proceeds to step 554 where the invitee has the opportunity to make as many comments as he desires (554). Typical comments may include “I can attend, but I have to leave at 6 pm”, “I can't attend, but I have accepted the invitation and one of my associates will be attending in my absence”, or “I can't attend, but if the conference call were moved to 4 pm, I could attend.” Invitee program 500 then proceeds to step 556. At step 556, invitee program 500 sends the RSVP back to the host and notifies monitor program 600 of the change in RSVP status of the invitee for the specified conference call, if any (556). Invitee program 500 then returns to step 508.

The third option the invitee has under the “conference call options” menu at step 508 is to review the RSVPs the invitee has already sent for future conference calls (558). Upon selecting this option, the invitee enters the name of the conference call he desires to edit (560). Invitee program 500 then makes a determination of whether the name entered by the invitee is recognized as a conference call stored in the system memory (562). If the name is not recognized, invitee program 500 notifies the invitee that the entered name is not a valid name and recites a list of conference calls stored in memory (564) and returns to step 560. Steps 560-564 can be omitted if the invitee is only invited to one conference call. If invitee program 500 recognizes the entered name, then invitee program 500 recites the details regarding the specified conference call (566). The details recited in step 566 include the date, time, location, telephone number and passcode, the RSVP deadline, current RSVP status (i.e. accepted, declined, etc.) and any comments that the host has attached to the invitation. Invitee program 500 then returns to step 508.

The fourth option the invitee has under the “conference call options” menu at step 508 is to quit invitee program 500 (568). The invitee may decide to quit invitee program 500 when he does not yet have enough information to make a decision as to accept to decline an invitation. In that case, the invitee either hangs up the telephone or enters a command which invitee program 500 will recognize as the invitee's intention to terminate invitee program 500.

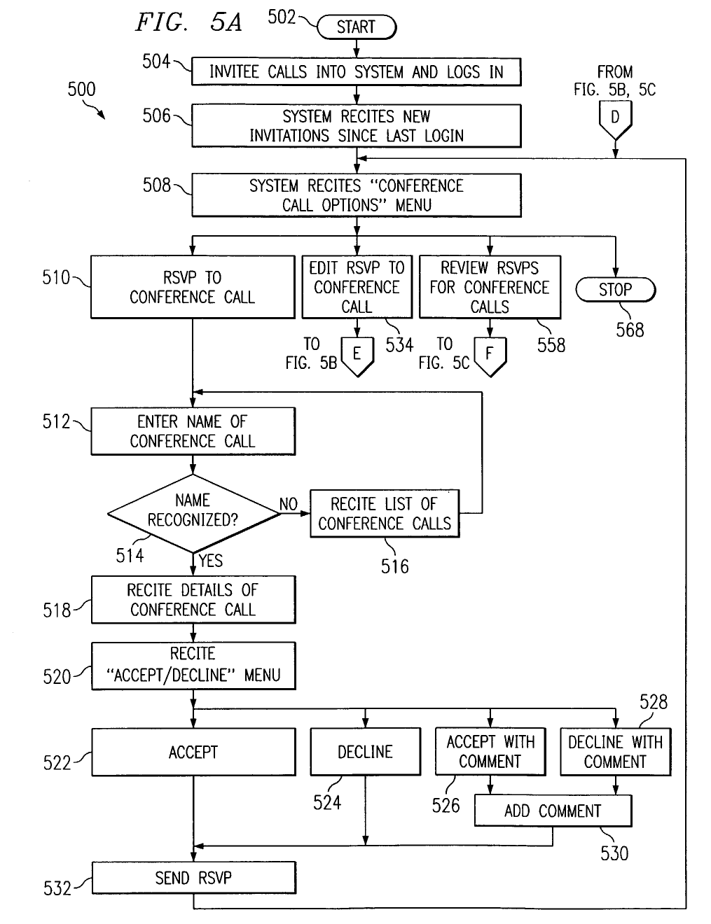

FIG. 6 is a flowsheet of the monitor program 600 which monitors the RSVP status of the invitees of the conference call. Monitor program 600 is used by the host of a conference call to not only monitor the invitees' RSVP status, but also to prompt the host to reserve the proper number of seats in the conference room or the proper number of conference call telephone lines. For example, if a third party conference call center is used, the host will be charged a fee for each telephone number and passcode he reserves for a conference call participant. Each telephone number and passcode that the host reserves for the conference call but is not used by a conference call participant represents wasted money. Likewise booking a large conference room when a smaller one will suffice represents wasted resources and/or money. Monitor program 600 is designed to minimize the amount of money wasted in this manner by keeping track of the invitees who will actually attend the conference call and notifying the host accordingly. Similarly, the host can refrain from reserving the conference call telephone number and passcode until after the RSVP deadline, so that he can reserve the exact number of lines required. Monitor program 600 starts (602) when the host creates a new conference call under step 408 and monitor program 600 acquires the list of invitees and the RSVP deadline from the host's input in steps 430 (604). Monitor program 600 then monitors host program 400 and/or invitee program 500 for RSVPs from the invitees (606). Monitor program 600 makes a record of the RSVP status (either accepting or declining, regardless of comments) of each of the invitees as they respond to the host's invitation for the conference call (608). When the RSVP deadline passes (610), monitor program 600 lists the non-responsive invitees as “declined due to no response” (612). Monitor program 600 then sends a message to the host and particular invitees indicating that the invitees who have not responded to the invitation have been marked as “declined due to no response” (614). As far as host program 400 and invitee program 500 are concerned, the message sent by monitor program 600 in step 612 can either appear as a general message on the host's or invitee's voicemail system, or preferably as a message indicating that the invitee has been marked as declining RSVP with the comment “declined due to no response”. Monitor program 600 then notifies the host of the attending and decline invitees (616). Monitor program 600 can notify the host through a variety of mediums including: leaving a message on the host's account, email, fax, telephone, or regular mail. Monitor program 600 then makes a determination whether host program 400 has obtained a telephone number and passcode for the conference call in step 418 (618). If host program 400 has done so, monitor program 600 ends (622). If host program 400 has not done so, monitor program 600 prompts host program 400 to obtain the telephone number and passcode for the conference call (620) and then monitor program 600 ends (622).

Typically, monitor program 600 will acquire the list of invitees and RSVP deadline when the host creates the conference call. However, the host does not necessarily have to specify the RSVP deadline when creating the conference call as he may not desire to specify the RSVP status at that time. In this case, monitor program 600 will create a default RSVP deadline of one hour before the conference call for the purposes of notifying the host of the RSVP status of the invitees.

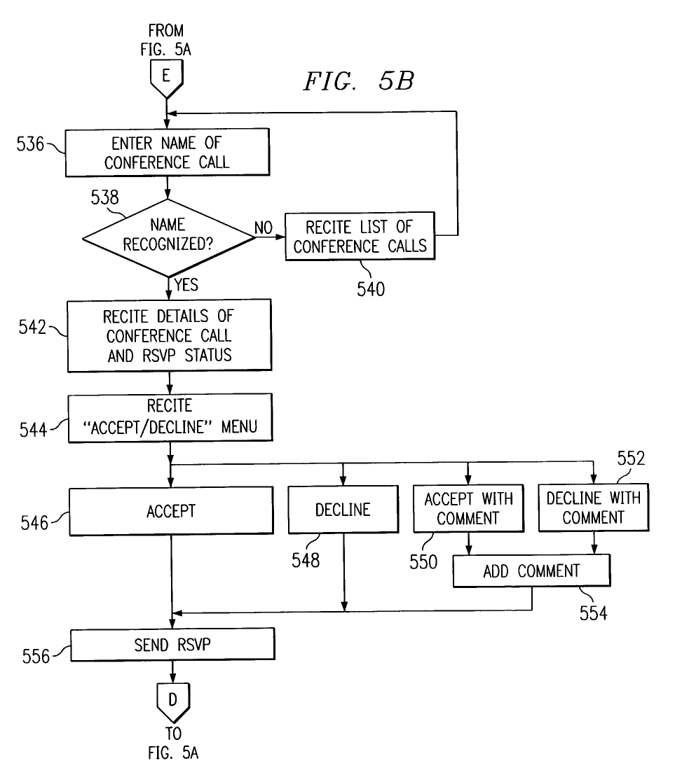

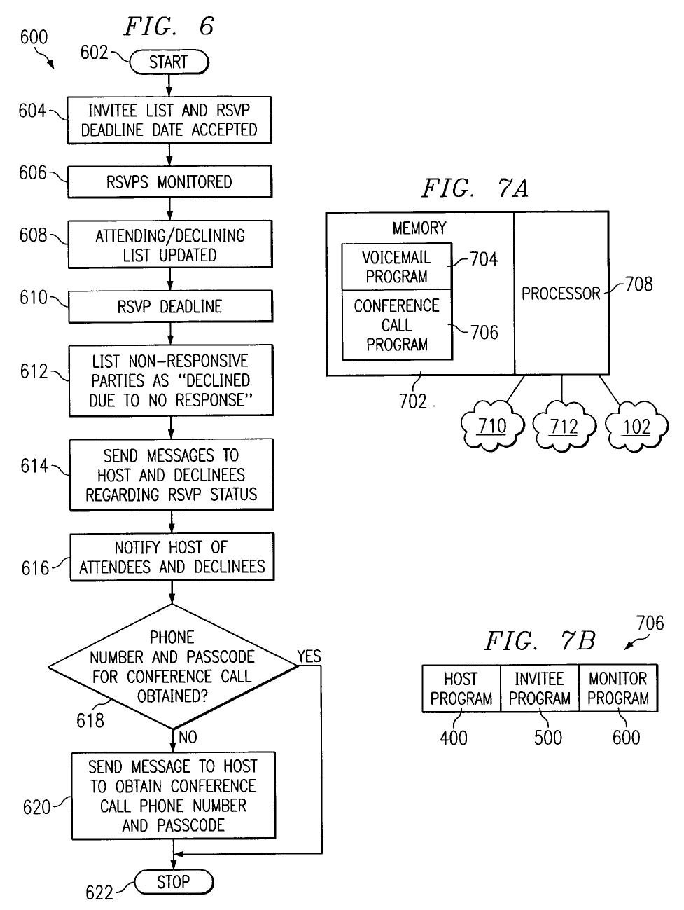

The present invention is an improvement on an existing voicemail infrastructure. As such, the present invention will be located in the memory of the system on which the user's (either host or invitee) voicemail system is located. FIG. 7A is an illustration of the memory 702 of the system on which the user's voicemail program 704 is implemented. Conference call program 706 which comprises host program 400, invitee program 500, and monitor program 600. Memory 702 is a storage facility for data for processor 708. Processor 708 can interface with cellular networks 710, traditional non-cellular networks 712, or the internet 102. Memory 702 and processor 708 may be a part of a system of a cellular service provider, a traditional noncellular telecommunications system, or any other system which contains a voicemail program.

FIG. 7B depicts conference call program 706 having host program 400, invitee program 500 and monitor program 600.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Additionally, the steps of the present invention need not be implemented in the order disclosed herein. The novel spirit of the present invention is still embodied by reordering or deleting some of the steps contained in this disclosure. The spirit of the invention is not meant to be limited in any way except by proper construction of the following claims.

What is claimed is:

1. A conference call program stored in the memory of a computer connected to a voice mail system comprising:
a host program;
an invitee program;
a monitor program;
wherein said host program, said invitee program, said monitor program, and said voice mail system cooperate to schedule a conference call.

2. The apparatus of claim 1 wherein said host program further comprises:
instructions for logging into a telecommunications system having the voice mail system;
instructions for specifying a time for an event to occur;
instructions for specifying at least one invitee to invite to said event;
instructions for communicating an invitation to said invitee;
instructions for receiving a response from said invitee; and
wherein said invitation is stored on said telecommunications system.

3. The apparatus of claim 1 wherein said invitee program further comprises:
instructions for receiving an invitation from a host;
instructions for logging into a telecommunications system having the voice mail system;
instructions for communicating a response to said host; and
wherein said invitation is stored on said telecommunications system.

4. The apparatus of claim 1 wherein said monitor program further comprises:
instructions for accepting a list of invitees;
instructions for accepting a deadline;
instructions for monitoring response of said invitees to an invitation;
instructions for creating an attendance record; and
instructions for entering said responses into said record.

5. A method of organizing a conference call using a conference call function stored in the memory of a computer connected to a voice mail system comprising:
logging into a telecommunications system having the voice mail system;
specifying a time for an event to occur;
specifying at least one invitee to invite to said event;
communicating an invitation to said invitee;
receiving a response from said invitee; and
wherein said invitation is stored on said telecommunications system.

6. The method of claim 5 wherein said steps of logging in, specifying, communicating, and receiving are conducted over a telephone.

7. The method of claim 5 wherein said response is stored on said telecommunications system.

8. The method of claim 5 wherein said telecommunications system,is the voicemail system.

9. The method of claim 8 wherein said voicemail system is the host's voicemail system.

10. The method of claim 5 wherein said event is a conference call.

11. The method of claim 5 further comprising the step of editing said invitation and communicating said edited invitation to said invitee.

12. The method of claim 5 further comprising reviewing the details of said invitation and reviewing said response from said invitee.

13. A method of responding to an invitation to a conference call using a conference call function stored in the memory of a computer connected to a voice mail system comprising:
receiving the invitation from a host;
logging into a telecommunications system having the voice mail system;
communicating a response to said host; and
wherein said invitation is stored on said telecommunications system.

14. The method of claim 13 wherein said steps of receiving, logging in, and communicating are conducted over a telephone.

15. The method of claim 13 wherein said response is stored on said telecommunications system.

16. The method of claim 13 wherein said telecommunications system is the voicemail system.

17. The method of claim 16 wherein said voicemail system is the host's voicemail system.

18. The method of claim 13 wherein said event is a conference call.

19. The method of claim 13 further comprising the step of editing said response and communicating said edited response to said host.

20. The method of claim 13 further comprising reviewing the details of said invitation and reviewing said response to said host.

21. A method of monitoring a guest list for a conference call using a conference call function stored in the memory of a computer connected to a voice mail system comprising:
accepting a list of a plurality of invitees;
accepting a deadline;
monitoring a response of each of said plurality of invitees to an invitation;
creating an attendance record; and
entering said plurality of responses into said record.

22. The method of claim 21 wherein when said deadline passes, marking said invitees which are non-responsive as a declining invitee.

23. The method of claim 21 further comprising the step of notifying a host of the responses of said invitees.

24. The method of claim 21 further comprising the step of making a determination of whether said host has obtained a telephone number and passcode for a conference call.

25. The method of claim 24 further comprising the step of prompting said host to obtain a telephone number and passcode for a conference call.

26. A programmable apparatus for organizing a conference call comprising:
a computer connected to a voice mail system;
a conference call function stored in the memory of the computer; and
wherein said computer is directed by said conference call program to perform steps comprising:
instructions for logging into a telecommunications system having the voice mail system;
instructions for specifying a time for an event to occur;
instructions for specifying at least one invitee to invite to said event;
instructions for communicating an invitation to said invitee;
instructions for receiving a response from said invitee; and
wherein said invitation is stored on said telecommunications system.

27. The apparatus of claim 26 wherein said steps of logging in, specifying, communicating, and receiving are conducted over a telephone.

28. The apparatus of claim 26 wherein said response is stored on said telecommunications system.

29. The apparatus of claim 26 wherein said telecommunications system is a voicemail system.

30. The apparatus of claim 29 wherein said voicemail system is the host's voicemail system.

31. The apparatus of claim 26 wherein said event is a conference call.

32. The apparatus of claim 26 further comprising instructions for editing said invitation and communicating said edited invitation to said invitee.

33. The apparatus of claim 26 further comprising instructions for reviewing the details of said invitation and reviewing said response from said invitee.

34. A programmable apparatus for responding to an invitation to a conference call comprising:
a computer connected to a voice mail system;
a conference call function stored in the memory of the computer; and
wherein said computer is directed by said conference call function to perform steps comprising:
instructions for receiving an invitation from a host;
instructions for logging into a telecommunications system having the voice mail system;
instructions for communicating a response to said host; and
wherein said invitation is stored on said telecommunications system.

35. The apparatus of claim 34 wherein said steps of receiving, logging in, and communicating are conducted over a telephone.

36. The apparatus of claim 34 wherein said response is stored on said telecommunications system.

37. The apparatus of claim 34 wherein said telecommunications system is the voicemail system.

38. The apparatus of claim 37 wherein said voicemail system is the host's voicemail system.

39. The apparatus of claim 34 wherein said event is a conference call.

40. The apparatus of claim 34 further comprising instructions for editing said response and communicating said edited response to said host.

41. The apparatus of claim 34 further comprising instructions for reviewing the details of said invitation and reviewing said response to said host.

42. A programmable apparatus for monitoring a conference call comprising:
a computer connected to a voice mail system;
a conference call function stored in the memory of the computer;
wherein said computer is directed by said conference call function to perform steps comprising:
instructions for accepting a list of a plurality of invitees;
instructions for accepting a deadline;
instructions for monitoring a response of each of said plurality of invitees to an invitation;
instructions for creating an attendance record; and
instructions for entering said plurality of responses into said attendance record.

43. The apparatus of claim 42 wherein when said deadline passes, marking said invitees which are non-responsive as declining.

44. The apparatus of claim 42 further comprising instructions for notifying a host of the responses of said invitees.

45. The apparatus of claim 42 further comprising instructions for making a determination of whether a host program has obtained a telephone number and passcode for a conference call.

46. The apparatus of claim 45 further comprising instructions for prompting said host program to obtain a telephone number and passcode for a conference call.

47. A system for organizing a conference call using a computer connected to a voice mail system and a conference call function stored in the memory of the computer comprising:
means for logging into a telecommunications system having the voice mail system;
means for specifying a time for an event to occur;
means for specifying at least one invitee to invite to said event;
means for communicating an invitation to said invitee;
means for receiving a response from said invitee; and
wherein said invitation is stored on said telecommunications system.

48. The system of claim 47 wherein said means for logging in, specifying, communicating, and receiving is a telephone.

49. The system of claim 47 wherein said response is stored on said telecommunications system.

50. The system of claim 47 wherein said telecommunications system is the voicemail system.

51. The system of claim 50 wherein said voicemail system is the host's voicemail system.

52. The system of claim 47 wherein said event is a conference call.

53. The system of claim 47 further comprising means for editing said invitation and communicating said edited invitation to said invitee.

54. The system of claim 47 further comprising means for reviewing the details of said invitation and means for reviewing said response from said invitee.

55. The system of claim 47 further comprising:
mans for receiving an invitation from a host;
means for logging into the telecommunications system;
means for communicating a response to said host; and
wherein said invitation is stored on said telecommunications system.

56. The system of claim 55 wherein said means for receiving, logging in, and communicating is a telephone.

57. The system of claim 55 wherein said response is stored on said telecommunications system.

58. The system of claim 55 wherein said telecommunications system is the voicemail system.

59. The system of claim 59 wherein said voicemail system is the host's voicemail system.

60. The system of claim 55 wherein said event is a conference call.

61. The system of claim 55 further comprising means for editing said response and communicating said edited response to said host.

62. The system of claim 55 further comprising means for reviewing the details of said invitation and reviewing said response to said host.
